(19) United States
(12) Patent Application Publication
(10) Pub. No.: US 2004/0218658 A1
(43) Pub. Date: Nov. 4, 2004

(54) Blue tooth temperature monitoring facility

(76) Inventor: Acer Ye, Hsin Chuang City (TW)

Correspondence Address: Acer Ye, P.O. Box 4-67, Hsin Chuang, Taipei, 242, TW

(21) Appl. No.: 10/429,560

(22) Filed: May 2, 2003

(51) Int. Cl. G01K 1/16

(52) U.S. Cl. 374/120

(57) ABSTRACT

A blue tooth body temperature monitoring facility includes a detecting device for attaching to a person required to be served, and for detecting body temperature or voice of the person, and includes a monitoring device to communicate with the detecting device with antennas, and to receive the information of the person. The care people may thus watch and monitor the status of the person at any time, or may receive emergency signals from the person, in order to make service to the person easily and quickly. The detecting device may also detect or monitor the communication status between the monitoring device and the detecting device.

### BACKGROUND OF THE INVENTION

1. Field of the Invention

The present invention relates to a body temperature watching or monitoring facility, and more particularly to a blue tooth body temperature monitoring facility for detecting or measuring and watching or monitoring the temperature and/or vibrations and/or noises of people wirelessly or remotely.

2. Description of the Prior Art

Various kinds of typical thermometers have been developed and widely used to sense or detect or measure the body temperatures of the users. After the body temperatures of the users have been sensed or detected or measured, the body temperatures of the users should be read and recorded by the users manually, and should be keyed into the computer facilities by the users manually, such that the information of the body temperatures of the users may not be easily sent into the computer facilities.

The other typical electrical thermometers have also been developed and widely used to sense or detect or measure the body temperatures of the users. For example, due to the widely separated severe acute respiratory syndrome (SARS) around the world, the body temperatures of many people should be sensed or detected or measured before the people may go into such as airplanes.

After the body temperatures of the users have been sensed or detected or measured, the body temperatures of the users may be shown in a display. However, the value of the body temperatures of the users should also be read and recorded by the users manually, and should be keyed into the computer facilities by the users manually, such that the information of the body temperatures of the users also may not be easily sent into the computer facilities for the typical electrical thermometers.

Particularly, in hospitals, many patients are required to be inspected or watched or monitored frequently by nurses and/or doctors, and the nurses and/or the doctors are required to take a lot of time to go and see the patients and to detect or measure the body temperature of the patients many times per day.

Similarly, for parents or for those persons who have to take care of many children, old people, or the like, the parents or the persons should also spend a lot of time to go and see the children, the old people, or the like, and to detect or measure the body temperature of the children, the old people, or the like many times per day. However, the parents or the persons may not easily know when will the children, the old people, or the like be required to be serviced, or when the children are crying.

The present invention has arisen to mitigate and/or obviate the afore-described disadvantages of the conventional thermometers.

### SUMMARY OF THE INVENTION

The primary objective of the present invention is to provide a blue tooth body temperature monitoring facility for detecting or measuring and watching or monitoring the body temperature and/or vibrations and/or noises of people wirelessly or remotely, and thus for allowing care people to make service to the patients or children right away.

In accordance with one aspect of the invention, there is provided a blue tooth body temperature monitoring facility comprising a detecting device for attaching to a person required to be served, the detecting device including an antenna and including means for detecting information of the person, and a monitoring device including an antenna, to communicate with the detecting device via the antennas, and to receive the information of the person.

The detecting device includes a blue tooth control device coupled to the antenna thereof, the detecting means includes a body temperature detecting circuit coupled to the blue tooth control device, to detect body temperature of the person. The detecting device includes a signal control circuit coupled between the body temperature detecting circuit and the blue tooth control device, to receive signals from the body temperature detecting circuit, and to send the signals to the blue tooth control device. The detecting device includes a signal processing circuit coupled to the signal control circuit, to process the signals from the body temperature detecting circuit and in the signal control circuit.

The detecting device includes a power supply circuit coupled between the signal control circuit and the blue tooth control device, to energize the signal control circuit and the blue tooth control device. The detecting device includes a battery coupled to the power supply circuit.

The detecting device may include a voice detecting circuit coupled to the blue tooth control device, to detect voice signals of the person. The detecting device includes a voice processing circuit coupled between the blue tooth control device and the voice detecting circuit, to process voice signals from the voice detecting circuit. The detecting device includes a microphone coupled to the voice processing circuit, to receive voice signals from the person. The detecting device includes a speaker coupled to the voice processing circuit, to generate sounds.

The detecting device includes an emergency calling circuit coupled to the blue tooth control device, to detect emergency signals from the person. The detecting device includes an emergency button coupled to the emergency calling circuit, to allow the person to generate the emergency signals.

The monitoring device includes a blue tooth control device coupled to the antenna thereof, a voice processing circuit coupled to the blue tooth control device, to process voice signals from the detecting device. The monitoring device includes an emergency calling circuit coupled between the blue tooth control device and the voice processing circuit to receive emergency signals from the detecting device.

The monitoring device includes a power supply circuit and a battery coupled to the blue tooth control device, to energize the blue tooth control device. The monitoring device includes a power interface circuit coupled between the power supply circuit and the battery, to protect the battery. The monitoring device includes a charging circuit and a rectifier coupled to the power interface circuit, for charging the battery.

The monitoring device includes a setting circuit coupled to the blue tooth control device, to set information into the blue tooth control device. The monitoring device includes a display coupled to the blue tooth control device to display the information.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a schematic view illustrating a blue tooth body temperature monitoring facility in accordance with the present invention;

FIG. 2 is a block diagram illustrating a measuring or detecting device of the temperature monitoring facility;

FIG. 3 is a block diagram illustrating a watching or monitoring device of the temperature monitoring facility; and

FIG. 4 is a block diagram illustrating the operation of the temperature monitoring facility.

### DETAILED DESCRIPTION OF THE PREFERRED EMBODIMENT

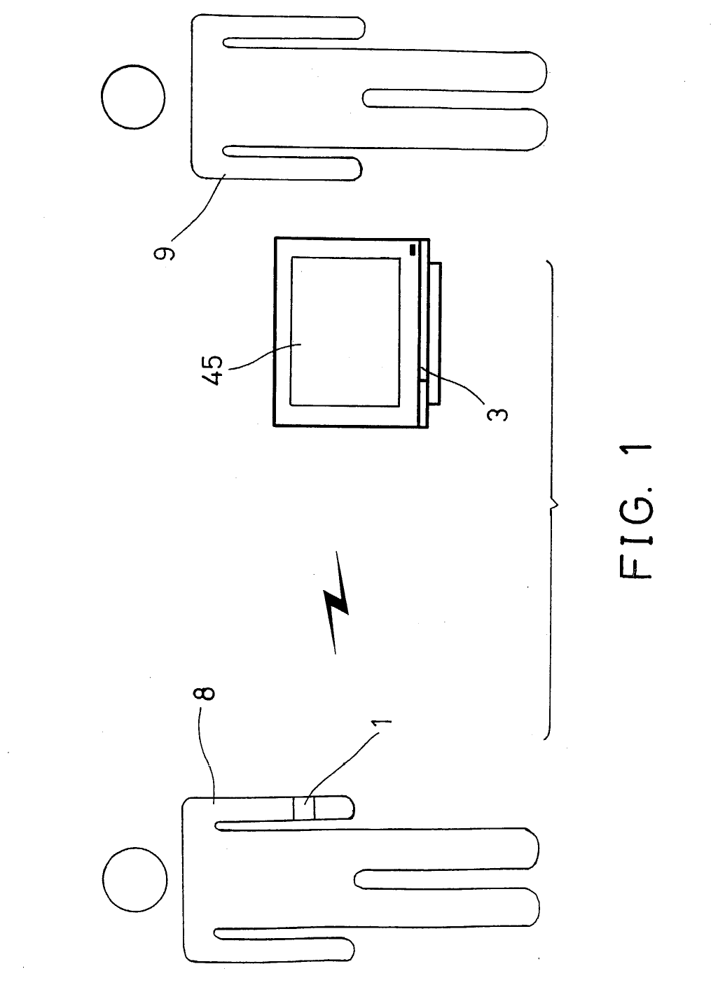

Referring to the drawings, and initially to FIG. 1, a blue tooth body temperature monitoring facility in accordance with the present invention includes a measuring or detecting device 1 to be attached to a person 8, such as to the waist portion of a patient, a child, an old person, or the like, to detect or measure the body temperature of the person 8, or to detect the vibrations or noises of the children 8.

The blue tooth body temperature monitoring facility further includes a watching or monitoring device 3 to receive signals from the detecting device 1, for allowing care people 9, such as nurses or doctors or parents or the like to serve the patients, the children, the old persons, or the like, when required, such as when the patients have a greatly increased body temperature, or when the children are crying, or when the old persons are asking for help, etc.

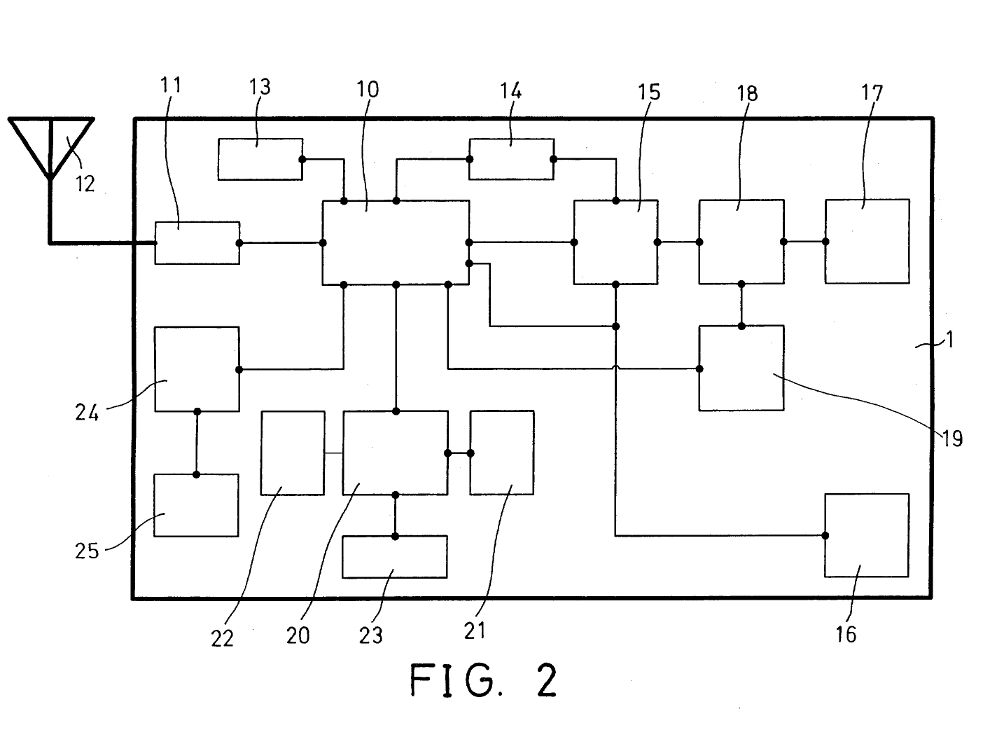

As shown in FIG. 2, the detecting device 1 of the blue tooth body temperature monitoring facility comprises a blue tooth control chip or circuit or device 10 for processing and/or receiving and/or converting and/or transmitting signals, such as blue tooth signals, a transmitting circuit 11 coupling the blue tooth control device 10 to an antenna 12 in order to receive signals from the antenna 12 or to transmit signals out through the antenna 12. The antenna 12 may also be directly coupled to the blue tooth control device 10.

A memory 13 is coupled to the blue tooth control device 10 for storing computer programs, packages, or various information or data. A resetting circuit 14 is coupled to the blue tooth control device 10 for resetting and/or mating the blue tooth control device 10, and for allowing the blue tooth control device 10 to be suitably worked or operated.

A power supply circuit 15 is coupled to the blue tooth control device 10 for supplying electric energy to energize various parts or elements of the detecting device 1, including at least the blue tooth control device 10, the transmitting circuit 11, the memory 13, and the resetting circuit 14, etc. One or more batteries 16 are coupled to the power supply circuit 15, for supplying electric energy to energize the detecting device 1 via the power supply circuit 15. The batteries 16 may also be directly coupled to the blue tooth control device 10.

A thermometer or a body temperature detecting circuit 17 may be coupled to the blue tooth control device 10 directly or indirectly via a signal control circuit 18 and/or the power supply circuit 15, and may be used to detect or to measure the body temperature of the person 8. The signal control circuit 18 is provided to receive and process the signals from the body temperature detecting circuit 17, and to send the processed signals to a signal processing circuit 19, and then to the blue tooth control device 10.

A voice processing circuit 20 is coupled to the blue tooth control device 10 for encoding or decoding voices from the persons 8, such as the patients, the children, the old persons, or the like. A voice detecting circuit 21 is coupled to the blue tooth control device 10 via the voice processing circuit 20, in order to detect the voice and/or the noise from the persons 8, such as the patients, the children, the old persons, or the like, so as to detect whether the patients or the old persons are asking for help or not, or whether the children are crying or not.

A microphone 22 is coupled to the blue tooth control device 10 via the voice processing circuit 20, in order to detect the voice and/or the noise from the persons 8, such as the patients, the children, the old persons, or the like, so as to convert the voice into signals and to send the signals to the blue tooth control device 10 via the voice processing circuit 20. A speaker 23 is also coupled to the blue tooth control device 10 via the voice processing circuit 20, in order to generate sounds or voice or the like.

An emergency calling circuit 24 is coupled to the blue tooth control device 10, for generating warning signals and/or for sending the warning signals to the blue tooth control device 10. An emergency button 25 is coupled to the emergency calling circuit 24, for allowing the persons 8, such as the patients, the children, the old persons, or the like, to depress the emergency button 25 and to ask for help from the people 9.

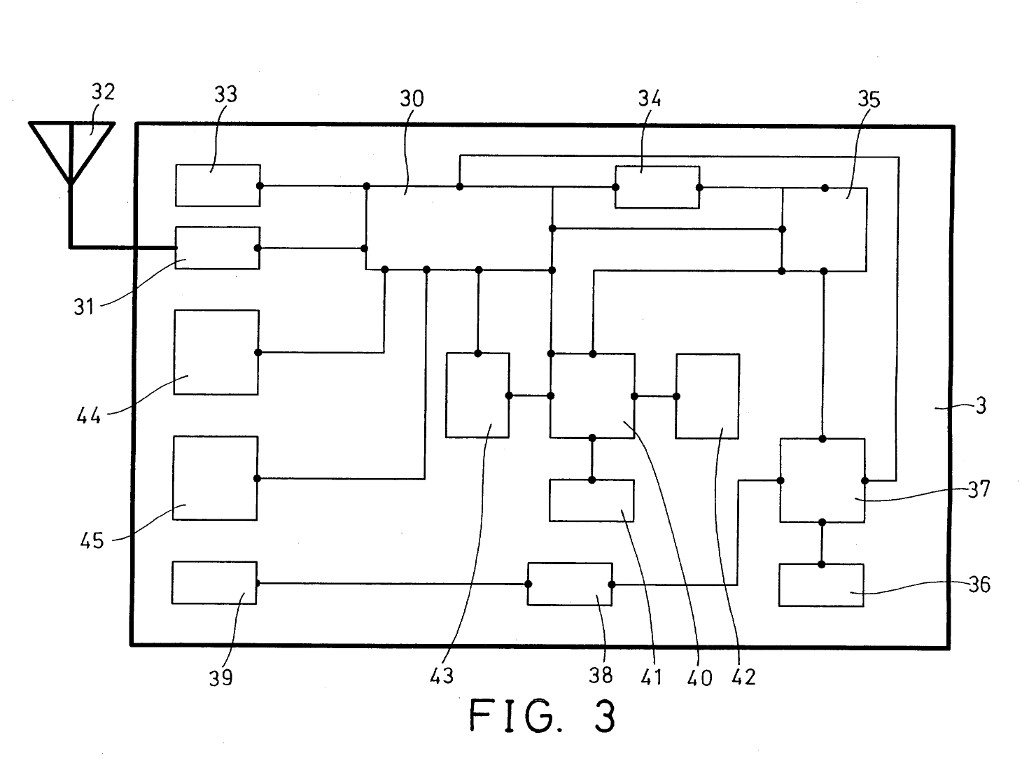

As shown in FIG. 3, the monitoring device 3 of the blue tooth body temperature monitoring facility comprises a blue tooth control chip or circuit or device 30 for processing and/or receiving and/or converting and/or transmitting signals, such as the blue tooth signals, a transmitting circuit 31 coupling the blue tooth control device 30 to an antenna 32 in order to receive signals from the detecting device 1 via the antenna 32 or to transmit signals out to the detecting device 1 through the antenna 32.

A memory 33 is coupled to the blue tooth control device 30 for storing computer programs, packages, or various information or data. A resetting circuit 34 is coupled to the blue tooth control device 30 for resetting and/or mating the blue tooth control device 30, and for allowing the blue tooth control device 30 to be suitably worked or operated.

A power supply circuit 35 is coupled to the blue tooth control device 30 for supplying electric energy to energize various parts or elements of monitoring device 3, including at least the blue tooth control device 30, the transmitting circuit 31, the memory 33, and the resetting circuit 34, etc. One or more batteries 36 are coupled to the power supply circuit 35 via a power interface circuit 37, for supplying electric energy to energize the monitoring device 3 via the power supply circuit 35. The power interface circuit 37 may be used to protect the batteries 36 from being overcharged, for example.

A charging circuit 38 is coupled to the power interface circuit 37, in order to recharge the batteries 36, and a rectifier 39 is coupled to the charging circuit 38, for coupling to various alternative current (AC) electric power sources of such as family houses, in order to convert the AC electric power sources into direct current (DC) electric power sources, and so as to supply the electric power energies to charge the batteries 36.

A voice processing circuit 40 is coupled to the blue tooth control device 30 for encoding or decoding voices signals of the persons 8 from the detecting device 1. A microphone 41 is coupled to the blue tooth control device 30 via the voice processing circuit 40, in order to detect the voice and/or the noise from the care people 9, such as the nurses, the doctors, the parents, or the like, so as to convert the voice into signals and to send the signals to the blue tooth control device 30 via the voice processing circuit 40. A speaker 42 is also coupled to the blue tooth control device 30 via the voice processing circuit 40, in order to generate sounds or voice or the like, for allowing the care people 9 and the persons 8 to be communicated with each other.

An emergency calling circuit 43 is coupled to the blue tooth control device 30 and/or the voice processing circuit 40, for generating warning signals and/or for sending the warning signals to the blue tooth control device 30 such as when the patients have a greatly increased body temperature, or when the children are crying, or when the old persons are asking for help, etc., and thus for allowing the care people 9 to watch or to service the persons 8.

A setting circuit 44 is coupled to the blue tooth control device 30 for inputting or keying or setting the predetermined values of the body temperatures of the persons 8, such as the patients, the children, the old persons, or the like, and/or the crying noise values of the children, and/or for sensing or detecting the communication status between the detecting device 1 and the monitoring device 3, and/or for sensing or detecting whether the electric circuit or energy status or value of the power supply circuit 35 and the batteries 36 and the power interface circuit 37 and the charging circuit 38 and the rectifier 39 is working well or not.

A display 45 is coupled to the blue tooth control device 30 for displaying the body temperatures of the persons 8, the crying noise values of the children, the information or the data set by the setting circuit 44, the electric energy status of the power supply circuit 35 and the batteries 36 and the power interface circuit 37 and the charging circuit 38 and the rectifier 39, or the like.

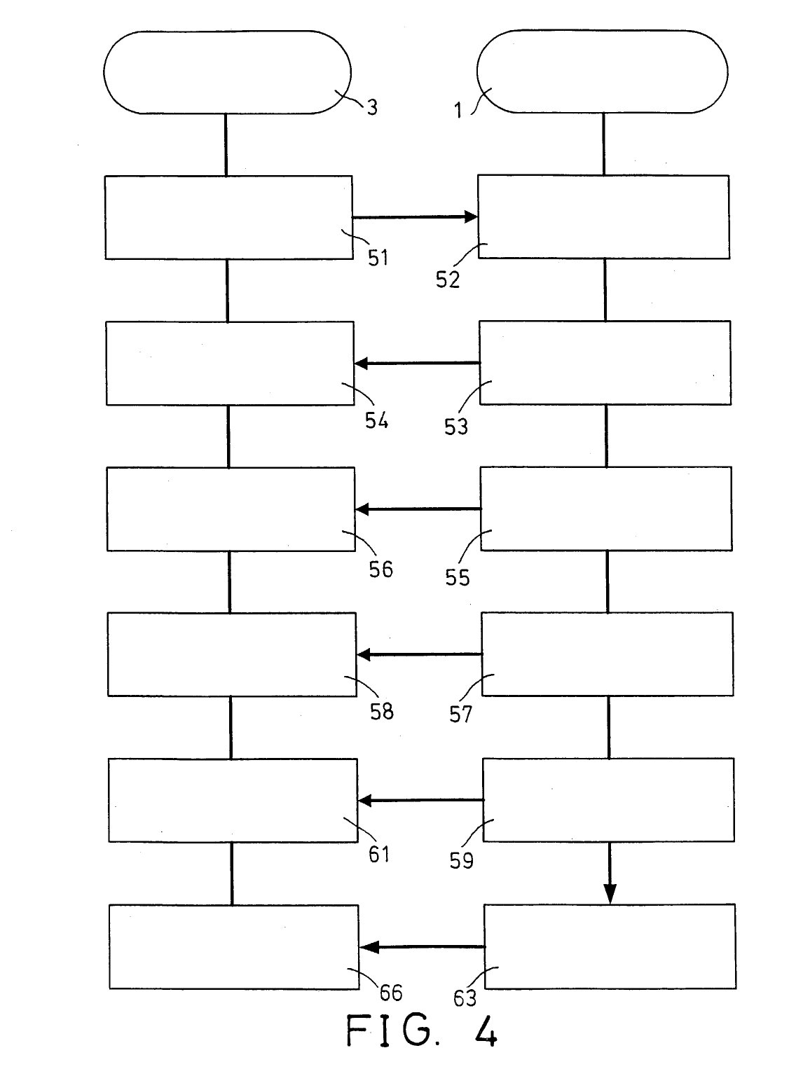

In operation, as shown in FIG. 4, in process 51, the setting circuit 44 of the monitoring device 3 is first used to input or key in or set the predetermined values of the body temperatures of the persons 8, and/or the crying noise values of the children, and/or the communication status between the detecting device 1 and the monitoring device 3, and/or the electric circuit or energy status or value of the power supply circuit 35 and the batteries 36 and the power interface circuit 37 and the charging circuit 38 and the rectifier 39 is working well or not. The data or information may be stored in the memory 33 of the monitoring device 3.

In process 52, the data or information stored in the memory 33 of the monitoring device 3 may then be sent to the blue tooth control device 30 of the monitoring device 3, and then sent to the blue tooth control device 10 of the detecting device 1 via the antenna members 12, 32, and then may be in the memory 13 of the detecting device 1.

In process 53, the body temperature detecting circuit 17 of the detecting device 1 may then be used to detect or to measure the body temperature of the person 8, and to send the value or signal of the body temperature of the person 8 to the signal control circuit 18. The signal processing circuit 19 may then process the newly detected value or signal of the body temperature of the person 8 from the signal control circuit 18, or may compare the newly detected value or signal of the body temperature of the person 8 with the previous body temperature of the person 8 stored in the memories 13, 33.

For example, when the newly detected body temperature of the person 8 has been increased over the previous body temperature of the person 8 stored in the memories 13, 33, or over a predetermined value or signal of the body temperature, the emergency calling circuit 24 may then be operated to generate warning signals in process 54, and the warning signals may also be sent to the monitoring device 3, in order to actuate the emergency calling circuit 43 of the monitoring device 3 to generate the warning signals by the speaker 42, in order to warn the people 9 that the person 8 has an over increased body temperature.

The value or signal of the body temperature of the person 8 may all be shown in the display 45 either when the body temperature of the person 8 has been increased over the previous body temperature of the person 8 stored in the memories 13, 33, or over the predetermined value or signal of the body temperature, or not, for allowing the people 9 to watch or to monitor the body temperature of the person 8 at any time.

Simultaneously, or after the process 53, the voice detecting circuit 21 and/or the microphone 22 of the detecting device 1 may be used to detect or to measure the noise or sound value of the person 8, particularly the children, in process 55, and to send the value or signal of the noise or sound of the person 8 to the blue tooth control device 30 via the voice processing circuit 20.

When the newly detected noise or sound value of the person 8 has been increased over the previous noise or sound value of the person 8 stored in the memories 13, 33, or over a predetermined value or signal of the noise or sound, the emergency calling circuit 24 may also be operated to generate warning signals in process 56, and the warning signals may also be sent to the monitoring device 3, in order to actuate the emergency calling circuit 43 of the monitoring device 3 to generate the warning signals by such as the speaker 42, in order to warn the people 9 that the person 8 is crying or is speaking, for example.

The newly detected noise or sound value of the person 8 may also be shown in the display 45 either when the newly detected noise or sound value of the person 8 has been increased over the previous noise or sound value of the person 8 stored in the memories 13, 33, or over the predetermined noise or sound value or not, for allowing the people 9 to watch or to monitor the noise or sound of the person 8 at any time.

Simultaneously, or after the processes 53, 55, the blue tooth control device 10 and/or the power supply circuit 15 of the detecting device 1 may be used to detect whether the communication status between the detecting device 1 and the monitoring device 3 is working well or not in process 57, and/or to sense or detect whether the electric circuit or energy status or value of the power supply circuit 15 and the batteries 16 is working well or not.

When the communication between the detecting device 1 and the monitoring device 3 is not working well, and/or when the electric circuit or energy status or value of the power supply circuit 15 and the batteries 16 is not working well, the emergency calling circuit 24 may also be operated to generate warning signals in process 58 and to actuate the emergency calling circuit 43 of the monitoring device 3 to generate the warning signals by such as the speaker 42, in order to warn the people 9 that the communication between the detecting device 1 and the monitoring device 3 is required to be checked and repaired, and/or the batteries 16 or 36 are required to be replaced with new ones, for example.

The communication status between the detecting device 1 and the monitoring device 3 and/or the status or value of the power supply circuit 15 and the batteries 16 may also be shown in the display 45.

Simultaneously, or after the processes 53, 55, 57, the person 8 may actuate the emergency calling circuit 24 via the emergency button 25, in order to send out signals to the people 9 via the antenna members 12, 32 and the blue tooth control devices 10, 30, in process 59. The speaker 42 will then generate the warning sound or signals in process 61 in order to warn the people 9 that the person 8 is required to be helped.

Simultaneously, or after the processes 53, 55, 57, 59, the people 9 and the person 8 may communicate with each other via the microphones 22, 41 and the antenna members 12, 32 of the blue tooth control devices 10, 30, in process 63. The people 9 may then make services to the person 8 right away in process 66.

The nurses and/or the doctors and/or the parents 9 may thus watch or monitor or detect or know the body temperature and/or the noise of the person 8, and/or the communication status between the detecting device 1 and the monitoring device 3 and/or the status or value of the power supply circuit 15 and the batteries 16 at any time, without going to see the person 8.

Accordingly, the blue tooth body temperature monitoring facility may be used for detecting or measuring and watching or monitoring the body temperature and/or vibrations and/or noises of people wirelessly or remotely, and thus for allowing care people to make service to the patients or children right away.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A blue tooth body temperature monitoring facility comprising:
a detecting device for attaching to a person required to be served, said detecting device including an antenna and including means for detecting information of the person, and
a monitoring device including an antenna, to communicate with said detecting device via said antennas, and to receive the information of the person.

2. The blue tooth body temperature monitoring facility as claimed in claim 1, wherein said detecting device includes a blue tooth control device coupled to said antenna thereof, said detecting means includes a body temperature detecting circuit coupled to said blue tooth control device, to detect body temperature of the person.

3. The blue tooth body temperature monitoring facility as claimed in claim 2, wherein said detecting device includes a signal control circuit coupled between said body temperature detecting circuit and said blue tooth control device, to receive signals from said body temperature detecting circuit, and to send the signals to said blue tooth control device.

4. The blue tooth body temperature monitoring facility as claimed in claim 3, wherein said detecting device includes a signal processing circuit coupled to said signal control circuit, to process the signals from said body temperature detecting circuit and in said signal control circuit.

5. The blue tooth body temperature monitoring facility as claimed in claim 3, wherein said detecting device includes a power supply circuit coupled between said signal control circuit and said blue tooth control device, to energize said signal control circuit and said blue tooth control device.

6. The blue tooth body temperature monitoring facility as claimed in claim 5, wherein said detecting device includes a battery coupled to said power supply circuit.

7. The blue tooth body temperature monitoring facility as claimed in claim 1, wherein said detecting device includes a blue tooth control device coupled to said antenna thereof, said detecting means includes a voice detecting circuit coupled to said blue tooth control device, to detect voice signals of the person.

8. The blue tooth body temperature monitoring facility as claimed in claim 7, wherein said detecting device includes a voice processing circuit coupled between said blue tooth control device and said voice detecting circuit, to process voice signals from said voice detecting circuit.

9. The blue tooth body temperature monitoring facility as claimed in claim 8, wherein said detecting device includes a microphone coupled to said voice processing circuit, to receive voice signals from the person.

10. The blue tooth body temperature monitoring facility as claimed in claim 8, wherein said detecting device includes a speaker coupled to said voice processing circuit, to generate sounds.

11. The blue tooth body temperature monitoring facility as claimed in claim 1, wherein said detecting device includes a blue tooth control device coupled to said antenna thereof, said detecting means includes an emergency calling circuit coupled to said blue tooth control device, to detect emergency signals from the person.

12. The blue tooth body temperature monitoring facility as claimed in claim 11, wherein said detecting device includes an emergency button coupled to said emergency calling circuit, to allow the person to generate the emergency signals.

13. The blue tooth body temperature monitoring facility as claimed in claim 1, wherein said monitoring device includes a blue tooth control device coupled to said antenna thereof, a voice processing circuit coupled to said blue tooth control device, to process voice signals from said detecting device.

14. The blue tooth body temperature monitoring facility as claimed in claim 13, wherein said monitoring device includes an emergency calling circuit coupled between said blue tooth control device and said voice processing circuit to receive emergency signals from said detecting device.

15. The blue tooth body temperature monitoring facility as claimed in claim 1, wherein said monitoring device includes a blue tooth control device coupled to said antenna thereof, a power supply circuit and a battery coupled to said blue tooth control device, to energize said blue tooth control device.

16. The blue tooth body temperature monitoring facility as claimed in claim 15, wherein said monitoring device includes a power interface circuit coupled between said power supply circuit and said battery, to protect said battery.

17. The blue tooth body temperature monitoring facility as claimed in claim 16, wherein said monitoring device includes a charging circuit and a rectifier coupled to said power interface circuit, for charging said battery.

18. The blue tooth body temperature monitoring facility as claimed in claim 1, wherein said monitoring device includes a blue tooth control device coupled to said antenna thereof, a setting circuit coupled to said blue tooth control device, to set information into said blue tooth control device.

19. The blue tooth body temperature monitoring facility as claimed in claim 18, wherein said monitoring device includes a display coupled to said blue tooth control device to display the information.
